(19) United States
(12) Patent Application Publication
(10) Pub. No.: US 2013/0290457 A1
(43) Pub. Date: Oct. 31, 2013

(54) METHOD AND APPARATUS FOR PROCESSING PRESENCE INFORMATION

(71) Applicant: Laurence Wang, Shanghai (CN)

(72) Inventor: Laurence Wang, Shanghai (CN)

(73) Assignee: ALCATEL LUCENT, Paris (FR)

(21) Appl. No.: 13/979,501

(22) PCT Filed: Jan. 3, 2012
(86) PCT No.: PCT/IB12/00064

§ 371 Date: Jul. 12, 2013

(30) Foreign Application Priority Data
Jan. 12, 2011 (CN) 201110021870.3

(51) Int. Cl. H04L 12/58

(52) U.S. Cl. CPC H04L 51/00
USPC 709/206

(57) ABSTRACT

A method for processing presence information in a network server is provided in the present invention. Firstly, receiving from a subscriber a definition request for defining a virtual publisher, and then assigning a unique identity for the virtual publisher, judging whether a data source list of the virtual publisher includes an unsubscribed data source and initiating a subscription to the unsubscribed data source. When receiving a notification message or a regular query result from a data source, determining virtual publisher(s) corresponding to the data source; for each of the virtual publishers, determining the latest state of the virtual publisher and sending a notification message including the latest state of the virtual publisher to a user in a subscriber list of the virtual publisher. By this method, a subscriber may voluntarily define information the subscriber requires rather than passively receiving, thereby providing customized information based on specific needs of a subscriber.

### FIELD OF THE INVENTION

The present invention relates to a communication network, and more particularly to a method and apparatus for processing presence information in the communication network.

### BACKGROUND OF THE INVENTION

Presence service is a service of obtaining presence information (e.g. user state, communication capability, personal preference, etc.) in real time by certain communication manner and according to certain access rule, and displaying it to other users, and plays a very important role in instant communication. Relying on presence technique, an instant communication service user may set the user state as “in a call”, “in a conference”, etc., and meanwhile set which communication capability it has and which communication manner it wants to be adopted in which state, and may subscribe communication state information of others so that both the calling party and the called party could choose the most appropriate communication manner in a specific occasion, thereby improving communication efficiency and quality.

The service model of the presence service is shown in FIG. 1. Publisher 101 is an information source of the presence service, and may be a user agent or a network agent, the user agent is capable of voluntarily publishing presence information, e.g. setting the state as “off”, “in a conference”, etc. Subscriber 102 is a subscriber and receiver of presence information, and can receive a notification message including presence information. Presence Server 103 is for achieving and performing presence service logic, including processing a subscription request, processing a publishing request, sending a notification, and operating an authorization rule, etc. In the presence service, Session Initial Protocol (SIP) is generally adopted at present. In the IP Multimedia Subsystem (IMS), a presence service is generally divided into steps of subscribing, publishing and notifying. Taking FIG. 1 as an example, Subscriber 102 subscribes the presence information of Publisher 101 from Presence Server 103, and after Publisher 101 receives the subscription request, it will publish its current state to Presence Server 103 every time when its state changes, and then Presence Server 103 will notify Subscriber 102.

Although in the prior arts, there have been some methods capable of providing a function of customizing presence information to a publisher, a method for achieving customization of presence information is still lacking for a subscriber, while in fact, there are often some situations that subscribers hope to obtain presence information defined by themselves instead of merely and passively receiving scattered and isolated presence states/information.

For example, user Tom hopes to know the online state of his friend John, while John has a plurality of terminals including mobile phone, office phone, and PC, etc., and then Tom must subscribe the states of all terminals of John and judge whether John is online through the obtained states of all terminals. For Tom, if he can obtain via one subscription a result of analyzing and processing the states of all terminals of John, it will be more convenient than obtaining via multiple subscriptions the isolated state of each terminal of John, but this function cannot be achieved by prior arts.

For another example, when monitoring hunderands of devices, a subscriber may hope to obtain general state information rather than single state information of all devices. The subscriber hopes to obtain normal, general state information when the states of all devices are normal, and the subscriber hopes to obtain abnormal, general state information when the state of one device is abnormal. However, by adopting the existing methods, the subscriber can only subscribe state information of all devices, and then obtain general state information by analyzing after obtaining state information of all devices. This is very inconvenient for the subscriber and will increase the load of the network due to a large number of messages.

Hence, it is necessary to provide a method capable of providing customized information base on specific needs of a subscriber.

### SUMMARY OF THE INVENTION

In order to overcome the aforesaid defect of the prior art, the present invention provides a method and apparatus for processing presence information in a network server.

According to the first aspect of the present invention, there is provided a method for processing presence information in a network server, comprising: A. receiving from a terminal a request message for defining a virtual publisher, the request message including a state list, a data source list, a state update rule and a subscriber list of the virtual publisher; B. assigning a unique identity to the virtual publisher; C. judging whether the data source list includes an unsubscribed data source and initiating a subscription to the unsubscribed data source.

Preferably, the data source list includes a presence information data source and/or a non-presence information data source.

Preferably, when the data source list includes a non-presence information data source, the request message further includes a query frequency and a query keyword for the non-presence information data source.

Preferably, the Step C further includes: when the unsubscribed data source is a presence information data source, sending a subscription request message to the unsubscribed data source.

Preferably, the Step C further includes: when the unsubscribed data source is a non-presence information data source, initiating a regular query process to the unsubscribed data source.

Preferably, the method further comprises: D1: receiving a notification message from a data source or receiving a regular query result from a data source, the notification message or the result including the latest state of the data source; D2: determining virtual publisher(s) corresponding to the data source; performing the following steps for each of the virtual publishers: D3: determining the latest state of the virtual publisher in accordance with the state update rule of the virtual publisher and the received, latest state of the data source; D4: sending a notification message including the latest state of the virtual publisher to a user in the subscriber list of the virtual publisher.

Preferably, the notification message in Step D4 further includes the latest state of the data source or an identity capable of accessing the latest state of the data source.

Preferably, the method further comprises: E1: receiving a subscription request message from a further terminal, the subscription request message including the unique identity of the virtual publisher and a subscriber identity; E2: judging whether the subscriber has a right for subscription; E3: if the subscriber has the right for subscription, adding the subscriber to the subscriber list of the virtual publisher; E4: sending a reply message of successful subscription to the further terminal.

According to the second aspect of the present invention, there is provided an apparatus for processing presence information in a network server, comprising: a first receiving device for receiving from a terminal a request message for defining a virtual publisher, the request message including a state list, a data source list, a state update rule and a subscriber list of the virtual publisher; an assigning device for assigning a unique identity for the virtual publisher; a data source subscription device for judging whether the data source list includes an unsubscribed data source and initiating a subscription to the unsubscribed data source.

Preferably, the data source list includes a presence information data source and/or a non-presence information data source.

Preferably, when the data source list includes a non-presence information data source, the request message further includes a query frequency and a query keyword for the non-presence information data source.

Preferably, the data source subscription device is further used for sending a subscription request message to the unsubscribed data source when the unsubscribed data source is a presence information data source.

Preferably, the data source subscription device is further used for starting a regular query process to the unsubscribed data source when the unsubscribed data source is a non-presence information data source.

Preferably, the apparatus further comprises: a second receiving device for receiving a notification message from a data source or receiving a regular query result from a data source, the notification message or the result including the latest state of the data source; a first determining device for determining the virtual publisher(s) corresponding to the data source; a second determining device for determining the latest state of the virtual publisher in accordance with the state update rule of the virtual publisher and the received latest state of the data source, for each of the virtual publishers; a first sending device for sending a notification message including the latest state of the virtual publisher to a user in the subscriber list of the virtual publisher, for each of the virtual publishers.

Preferably, the notification message sent by the first sending device further includes the latest state of the data source or an identity capable of accessing the latest state of the data source.

Preferably, the apparatus further comprises: a third receiving device for receiving from a further terminal a subscription request message including the unique identity of the virtual publisher and a subscriber identity; a judging device for judging whether the subscriber has a right for subscription; a subscriber management device for adding the subscriber to the subscriber list of the virtual publisher when the subscriber has the right for subscription; a second sending device for sending a reply message of successful subscription to the further terminal.

By using the method and apparatus of the present invention, customized information can be provided based on specific needs of subscribers, and the subscribers may voluntarily define the information they need rather than passively receiving the information published by the publisher. Moreover, besides obtaining presence information, subscribers may also obtain information from a non-presence information data source. Based on requirements, a user may integrate multiple data sources (presence information data sources or non-presence information data sources) in accordance with the user customized rule, by defining a virtual publisher, and obtain a real-time state update of the virtual publisher through presence information. Facing mass and rapidly changing network information and various information requirements of users, the present invention provides a unified information platform/window based on the existing presence information service standard. A user may easily and in real time track scattered and rapidly changing information in network, via the virtual publisher defined by the user. The present invention can be widely used throughout life and production, e.g. information tracking, device monitoring/managing, service monitoring/managing, etc.

### BRIEF DESCRIPTION OF THE DRAWINGS

Other features, objects and advantages of the present invention will become more obvious by making references to the following detailed description of nonrestrictive embodiments in conjunction with the accompanying drawings.

FIG. 1 is a schematic diagram illustrating the service model of the presence service.

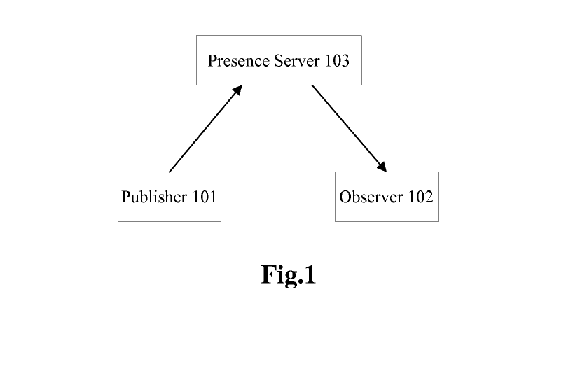

FIG. 2 is a flowchart of processing presence information in a network server according to a specific embodiment of the present invention.

FIG. 3 is a schematic diagram illustrating the structure of an apparatus for processing presence information in a network server according to a specific embodiment of the present invention.

### DETAILED DESCRIPTION OF EMBODIMENTS

Firstly, explanations are made to the following concepts used in this application.

Presence information: referring to data representing user online, communication will and terminal information. The definition and composition of presence information are specified in detail in IETF RFC3863, and usually presence information is described in a Presence Information Data Format (PIDF).

Non-presence information: referring to information that does not conform to relevant standard stipulation, e.g. information obtained by looking up the database, information extracted from WEB by certain technique, etc.

Presence information data source: referring to a network entity capable of providing presence information.

Non-presence information data source: referring to a network entity incapable of providing presence information.

The present invention needs to introduce a new function entity, which may be a new individual network entity and may also exist in an existing network server, e.g. a presence server, a Serving Call Session Control Function (S-CSCF) device, etc.

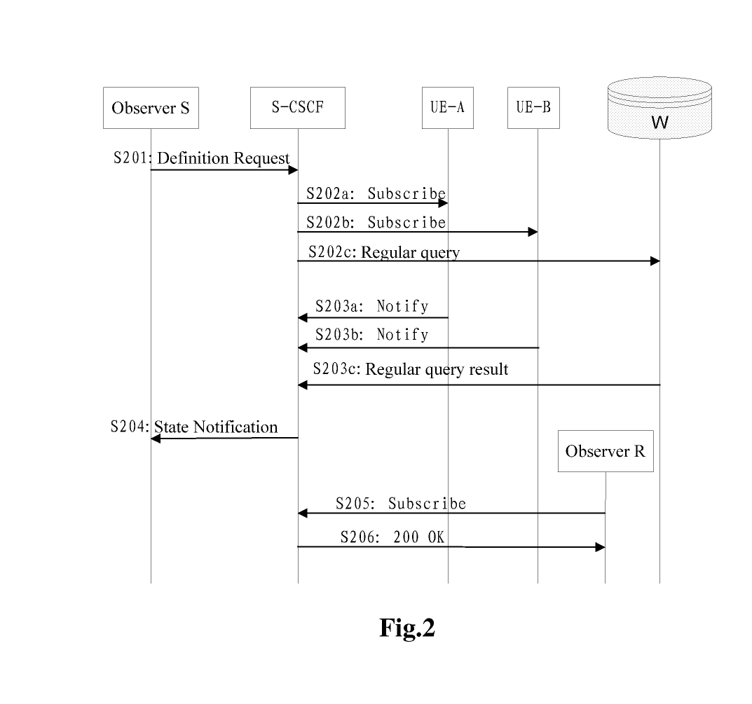

FIG. 2 illustrates the flowchart of processing presence information in a network server according to a specific embodiment of the present invention. In FIG. 2, the new function entity exists in S-CSCF. UE-A and UE-B are presence information data sources; W is a non-presence information data source.

Firstly, in Step S201, Observer S sends a definition request message to S-CSCF, the definition request is for defining a virtual publisher. Observer S may achieve the definition of the virtual publisher by adopting various existing techniques, e.g. by Web page, by dialing the customer service number or by other means. The definition request message may be one or more, e.g. completing the parameters required for defining a virtual publisher by multiple interactions with S-CSCF.

The definition request at least includes the following parameters.

A state list: for defining a state corresponding to a virtual publisher.

A data source list: for defining based on information of which data source(s), the state of the virtual publisher is updated. Preferably, the data sources may be presence information data sources and may also be non-presence information data sources.

A state update rule: for defining a computing rule, an update opportunity, etc. of a state of a virtual publisher obtained from information of data sources. For the update opportunity, it may be a timely updating when receiving a state notification of a data source, and may also be a regular updating at regular intervals.

A subscriber list: for defining a list of users subscribing the state of the virtual publisher. Generally, the definer, i.e. Observer S is one of the subscribers.

For the case that the data source list including a non-presence information data source, the definition request should further include a query frequency and a query keyword for the non-presence information data source.

For example, in one embodiment, Observer S defines a virtual publisher X which determines its online state in accordance with the online states of terminals UE-A and UE-B. The definition request message for defining the virtual publisher X at least should include the following parameters:

a state list: {online, offline};

a data source list: {UE-A, UE-B};

a state update rule: {if UE-A is online or UE-B is online, then X is online; if UE-A is offline and UE-B is offline, then X is offline; timely updating};

a subscriber list: {Observer S}.

For example, in another embodiment, Observer S defines a virtual publisher Y which determines its state in accordance with a state of terminal UE-B and a query result of data source W.

The definition request message for defining the virtual publisher Y at least should include the following parameters:

a state list: {S1, S2};

a data source list: {UE-B, W (a query keyword of W, a query frequency of W)};

a state update rule: {if the state query result of W is w1, then the state of Y is S1; if the state of UE-B is online and the state query result of W is w2, then the state of Y is S2; updating every five minutes};

a subscriber list: {Observer S}.

In the definition request, Observer S may further define the name of the virtual publisher so as to display it to a subscriber.

After S-CSCF receives the definition request message, it firstly assigns a unique network identifiable identity to the virtual publisher. For example, in the IMS network, the identity may be IMS Public User ID.

The definition information and assigned unique identity of the virtual publisher will be stored in S-CSCF.

Then, S-CSCF will start a subscribing process, i.e. judging whether the data source list specified in the definition request message includes an unsubscribed data source and initiating a subscription to the unsubscribed data source.

If the unsubscribed data source is a presence information data source, then S-CSCF will send a subscription request message to the unsubscribed data source. For example, S-CSCF judges that the unsubscribed data source includes UE-A or UE-B, then S-CSCF will initiate a subscription to the UE-A or UE-B and execute Steps S202a or S202b in FIG. 2, i.e. send a Subscribe message to the UE-A or send a Subscribe message to the UE-B.

If the unsubscribed data source is a non-presence information data source, then S-CSCF will start a regular query process to the unsubscribed data source. For example, S-CSCF judges that the unsubscribed data source includes W, and then S-CSCF will initiate a subscription to W, and execute Step S202c in FIG. 2, i.e. start a regular query process to W, while the keyword and query frequency required by the query have been recited in the definition request.

For example, when S-CSCF receives a definition request message about the virtual publisher X, if UE-A and UE-B are unsubscribed, then S-CSCF will perform Steps S202a and S202b in FIG. 2, i.e. send the Subscribe message respectively to UE-A and UE-B.

For example, when S-CSCF receives a definition request message about the virtual publisher Y, if UE-B and W are unsubscribed, then S-CSCF will perform Steps S202b and S202c in FIG. 2, i.e. send the Subscribe message to UE-B and start a regular query process for W.

After finishing the subscription, S-CSCF marks the subscribed data sources with “subscribed” for subsequent use.

A subscribed presence information data source will notify S-CSCF after its state changes, for example, after UE-A or UE-B in FIG. 2 is subscribed, if its state changes, it will perform Step S203a or S203b, i.e. send a Notify message to S-CSCF; the Notify message includes the latest state of the UE-A or UE-B, and the latest state is described in a presence information manner.

After S-CSCF starts a regular query for a subscribed non-presence information data source, the subscribed non-presence information data source will notify S-CSCF of a query result, for example, after W in FIG. 2 is subscribed, S-CSCF will query it in accordance with a specified query frequency and keyword, and W will perform Step S203c, i.e. send a query result to S-CSCF; the query result includes the latest state of W, and the latest state is described in a non-presence information manner.

When S-CSCF receives a notification message from a presence information data source or a regular query result from a non-presence information data source, it will firstly determine virtual publisher(s) corresponding to the data source. For example, when S-CSCF receives a Notify message from UE-B, it will determine the virtual publishers corresponding to the UE-B data source are X and Y; when S-CSCF receives a regular query result from W, it will determine the virtual publisher corresponding to W is Y.

Secondly, for each determined virtual publisher, S-CSCF determines the latest state of the virtual publisher in accordance with the state update rule of the virtual publisher and the received latest state of the data source.

For example, the Notify message received by S-CSCF from UE-B indicates that the state of UE-B is updated to online, and then for the virtual publisher X, if the state of UE-A stored in S-CSCF is online, the latest state of X is immediately updated to be “online” in accordance with the computing rule and update opportunity in its state update rule; for the virtual publisher Y, if the state of W stored in S-CSCF is w2, the latest state of Y is updated to be S2 after a 5-minute interval from the last update, in accordance with the computing rule and update opportunity in its state update rule.

Then, for each determined virtual publisher, S-CSCF will send a notification message including the latest state of the virtual publisher to a user in its subscriber list. For example, for virtual publisher X, the user in its subscriber list is Observer S, then S-CSCF will perform Step S204 in FIG. 2, i.e. send to Observer S a state notification message including the latest state - - - “online” state of X; for virtual publisher Y, the user in its subscriber list is Observer S, then S-CSCF will perform Step S204 in FIG. 2, i.e. send to Observer S a state notification message including the latest state - - - w2 of Y.

Preferably, the notification message further includes the latest state of the data source or an identity capable of accessing the latest state of the data source. For example, the notification message sent to Observer S further includes the latest state of the data source UE-B, or a Universal Resource Locator (URL) capable of accessing the latest state of the UE-B, or other identities, besides the latest state of the virtual publisher X or the virtual publisher Y.

After Observer S defines a virtual publisher and S-CSCF assigns a unique identity to it, other observers may also subscribe the state of the virtual publisher. This process is illustrated by Step S205 to Step S206 in FIG. 2.

In Step S205, Observer R sends to S-CSCF a Subscribe message including a unique identity of a virtual publisher to be subscribed and the identity of the Observer R per se. For example, if Observer R intends to subscribe the state of virtual publisher X, then the Subscribe message should include the unique identity of the virtual publisher X; if Observer R intends to subscribe the state of virtual publisher Y, then the Subscribe message should include the unique identity of the virtual publisher Y.

After receiving the subscription request message, S-CSCF will judge whether Observer R has a right for subscription.

If Observer R is judged to have the right for subscription, it will be added to the subscriber list of the virtual publisher. For example, if the Subscribe message sent by Observer R includes the unique identity of the virtual publisher X, then Observer R will be added to the subscriber list of the virtual publisher X; if the Subscribe message sent by Observer R includes the unique identity of the virtual publisher Y, then Observer R will be added to the subscriber list of the virtual publisher Y.

Then, S-CSCF will send to Observer R a 200OK message representing a successful subscription, as illustrated by Step S206 in FIG. 2.

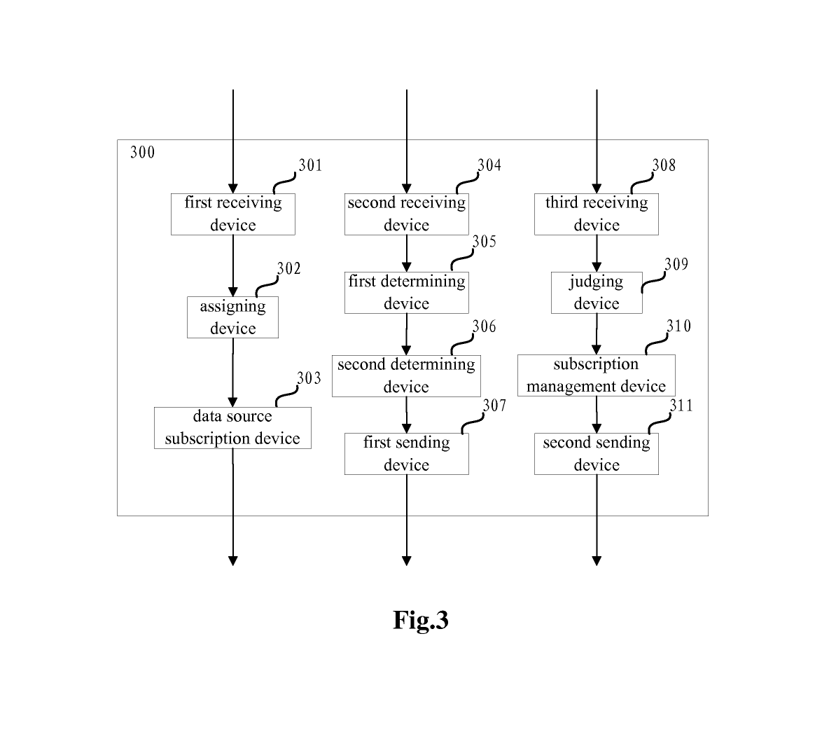

FIG. 3 is a schematic diagram illustrating the structure of an apparatus 300 for processing presence information in a network server according to a specific embodiment of the present invention. The apparatus comprises: a first receiving device 301, an assigning device 302, a data source subscription device 303, a second receiving device 304, a first determining device 305, a second determining device 306, a first sending device 307, a third receiving device 308, a judging device 309, a subscriber management device 310 and a second sending device 311.

The working process of the apparatus 300 will be described in detail in the following in conjunction with FIG. 2. In FIG. 2, the apparatus 300 is located in S-CSCF, and in fact, it may also be located in another network server or exist alone.

Firstly, in Step S201, the first receiving device 301 receives a definition request message from Observer S, the definition request is for defining a virtual publisher. Observer S may achieve the definition of the virtual publisher by adopting various existing techniques, e.g. by Web page, by dialing the customer service number or by other means. The definition request message may be one or more, e.g. completing the parameters required for defining a virtual publisher by multiple interactions with S-CSCF.

The definition request at least includes the following parameters: a state list, a data source list, a state update rule and a subscriber list. Regarding the meanings of these parameters, they have been described above in detail, and here we will not go further on them.

Preferably, the data source may be a presence information data source, and may also be a non-presence information data source.

For the case that a data source list including a non-presence information data source, the definition request should further include a query frequency and a query keyword of the non-presence information data source.

For example, in one embodiment, Observer S defines a virtual publisher X which determines its online state in accordance with the online states of terminals UE-A and UE-B. The definition request message for defining the virtual publisher X at least should include the following parameters:

a state list: {online, offline};

a data source list: {UE-A, UE-B};

a state update rule: {if UE-A is online or UE-B is online, then X is online; if UE-A is offline and UE-B is offline, then X is offline; timely updating};

a subscriber list: {Observer S}.

For example, in another embodiment, Observer S defines a virtual publisher Y which determines its state in accordance with a state of terminal UE-B and a query result of data source W.

The definition request message for defining the virtual publisher Y at least should include the following parameters:

a state list: {S1, S2};

a data source list: {UE-B, W (a query keyword of W, a query frequency of W)};

a state update rule: {if the state query result of W is w1, then the state of Y is S1; if the state of UE-B is online and the state query result of W is w2, then the state of Y is S2; updating every five minutes};

a subscriber list: {Observer S}.

In the definition request, Observer S may further define the name of a virtual publisher so as to display it to a subscriber.

When the first receiving device 301 receives the definition request message, the assigning device 302 will assign a unique network identifiable identity to the virtual publisher. For example, in the IMS network, the identity may be an IMS Public User ID.

The definition information and assigned unique identity of the virtual publisher will be stored in S-CSCF.

Then, the data source subscription device 303 will start a subscribing process, i.e. judging whether the data source list specified in the definition request message includes an unsubscribed data source and initiating a subscription to the unsubscribed data source.

If the unsubscribed data source is a presence information data source, then the data source subscription device 303 will send a subscription request message to the unsubscribed data source. For example, the data source subscription device 303 judges that the unsubscribed data source includes UE-A or UE-B, then the data source subscription device 303 will initiate a subscription to the UE-A or UE-B as illustrated by Step S202a or S202b in FIG. 2, i.e. send a Subscribe message to the UE-A or send a Subscribe message to the UE-B.

If the unsubscribed data source is a non-presence information data source, then the data source subscription device 303 will start a regular query process to the unsubscribed data source. For example, the data source subscription device 303 judges that the unsubscribed data source includes W, and then the data source subscription device 303 will initiate a subscription to W as illustrated by Step S202c in FIG. 2, i.e. start a regular query process to W, while the keyword and query frequency required by a query have been recited in the definition request.

For example, when the first receiving device 301 receives a definition request message about the virtual publisher X, if the data source subscription device 303 judges that both UE-A and UE-B are unsubscribed, then the data source subscription device 303 will perform Steps S202a and S202b in FIG. 2, i.e. send the Subscribe message respectively to UE-A and UE-B.

For example, when the first receiving device 301 receives a definition request message about the virtual publisher Y, if the data source subscription device 303 judges that both UE-B and W are unsubscribed, then the data source subscription device 303 will perform Steps S202b and S202c in FIG. 2, i.e. send the Subscribe message to UE-B and start a regular query process for W.

After finishing the subscription, the data source subscription device 303 marks the subscribed data sources with “subscribed” for subsequent use.

A subscribed presence information data source will notify S-CSCF after its state changes, for example, after UE-A or UE-B in FIG. 2 is subscribed, if its state changes, it will perform Step S203a or S203b, i.e. send a Notify message to S-CSCF; the Notify message includes the latest state of the UE-A or UE-B, and the latest state is described in a presence information manner.

After the data source subscription device 303 starts a regular query for a subscribed non-presence information data source, the subscribed non-presence information data source will notify S-CSCF of a query result, for example, after W in FIG. 2 is subscribed, the data source subscription device 303 will query it in accordance with a specified query frequency and keyword, and W will perform Step S203c, i.e. send a query result to S-CSCF; the query result includes the latest state of W, and the latest state is described in a non-presence information manner.

When the second receiving device 304 receives a notification message from a presence information data source or a regular query result from a non-presence information data source, the first determining device 305 will firstly determine the virtual publisher(s) corresponding to the data source. For example, when the second receiving device 304 receives a Notify message from UE-B, the first determining device 305 will determine the virtual publishers corresponding to the UE-B data source are X and Y; when the second receiving device 304 receives a regular query result from W, the first determining device 305 will determine the virtual publisher corresponding to W is Y.

Secondly, for each determined virtual publisher, the second determining device 306 determines the latest state of the virtual publisher in accordance with the state update rule of the virtual publisher and the received latest state of the data source.

For example, the Notify message received by the second receiving device 304 from UE-B indicates that the state of UE-B is updated to online, and then for virtual publisher X, if the state of UE-A stored in S-CSCF is online, the second determining device 306 immediately updates the latest state of X to be “online” in accordance with the computing rule and the update opportunity in its state update rule; for virtual publisher Y, if the state of W stored in S-CSCF is w2, the second determining device 306 updates the latest state of Y to be S2 after a 5-minute interval from the last update, in accordance with the computing rule and the update opportunity in its state update rule.

Then, for each determined virtual publisher, the first sending device 307 will send a notification message including the latest state of the virtual publisher to a user in its subscriber list. For example, for virtual publisher X, the user in its subscriber list is Observer S, then the first sending device 307 will perform Step S204 in FIG. 2, i.e. send to Observer S a state notification message including the latest state - - - “online” state of X; for virtual publisher Y, the user in its subscriber list is Observer S, then the first sending device 307 will perform Step S204 in FIG. 2, i.e. send to Observer S a state notification message including the latest state - - - w2 of Y. The state information of the notification message is described in a presence information manner.

Preferably, the notification message further includes the latest state of the data source or an identity capable of accessing the latest state of the data source. For example, the notification message sent to Observer S further includes the latest state of the data source UE-B, or a URL capable of accessing the latest state of the UE-B, or other identities, besides the latest state of the virtual publisher X or the virtual publisher Y.

After Observer S defines a virtual publisher and the assigning device 302 assigns a unique identity to it, other observers may also subscribe the state of the virtual publisher. This process is illustrated by Step S205 to Step S206 in FIG. 2.

In Step S205, the third receiving device 308 receives a Subscribe message sent by Observer R, the Subscribe message including a unique identity of the virtual publisher to be subscribed and the identity of the Observer R per se. For example, if Observer R intends to subscribe the state of virtual publisher X, then the Subscribe message should include the unique identity of the virtual publisher X; if Observer R intends to subscribe the state of virtual publisher Y, then the Subscribe message should include the unique identity of the virtual publisher Y.

After the third receiving device 308 receives the subscription request message, the judging device 309 will judge whether Observer R has a right for subscription.

If the judging device 309 judges that Observer R has the right for subscription, the subscriber management device 310 will add Observer R to the subscriber list of the virtual publisher. For example, if the Subscribe message sent by Observer R includes the unique identity of the virtual publisher X, then the subscriber management device 310 will add Observer R to the subscriber list of the virtual publisher X; if the Subscribe message sent by Observer R includes the unique identity of the virtual publisher Y, then the subscriber management device 310 will add Observer R to the subscriber list of the virtual publisher Y.

Then, the second sending device 311 will send to Observer R a 200OK message representing a successful subscription, as illustrated by Step S206 in FIG. 2.

For those skilled in the art, the present invention is obviously not limited to the details of the illustrative embodiments, and it can be carried out in other specific forms without departure from the spirit or basic features of the present invention. Therefore, no matter from which point of view, the embodiments shall be regarded as illustrative and non-restrictive. The scope of the present invention is defined by the appended claims rather than the above explanations, and thus the present invention aims to include all changes within the meaning and scope of equivalent key elements of the claims. In addition, the word “comprise” obviously does not exclude other units or steps, and the singular form does not exclude the plural form. The words of first, second, etc. are used to represent names rather than any specific sequence.

1. A method for processing presence information in a network server, comprising:
receiving from a terminal a request message for defining a virtual publisher, the request message including a state list, a data source list, a state update rule and a subscriber list of the virtual publisher;
assigning a unique identity to the virtual publisher;
judging whether the data source list includes an unsubscribed data source and initiating a subscription to the unsubscribed data source.

2. The method according to claim 1, wherein: the data source list includes a presence information data source and/or a non-presence information data source.

3. The method according to claim 1, wherein: when the data source list includes a non-presence information data source, the request message further includes a query frequency and a query keyword for the non-presence information data source.

4. The method according to claim 1, wherein: judging whether the data source list includes an unsubscribed data source and initiating a subscription to the unsubscribed data source further includes:
when the unsubscribed data source is a presence information data source, sending a subscription request message to the unsubscribed data source.

5. The method according to claim 1, wherein: judging whether the data source list includes an unsubscribed data source and initiating a subscription to the unsubscribed data source further includes:
when the unsubscribed data source is a non-presence information data source, staring a regular query process to the unsubscribed data source.

6. The method according to claim 1, wherein: the method further includes:
receiving a notification message from a data source or receiving a regular query result from a data source, the notification message or the result including the latest state of the data source;
determining virtual publisher(s) corresponding to the data source;
performing the following steps for each of the virtual publishers:
determining the latest state of the virtual publisher in accordance with the state update rule of the virtual publisher and the received latest state of the data source;
sending a notification message including the latest state of the virtual publisher to a user in the subscriber list of the virtual publisher.

7. The method according to claim 6, wherein: the notification message in sending a notification message including the latest state of the virtual publisher to a user in the subscriber list of the virtual publisher further includes the latest state of the data source or an identity capable of accessing the latest state of the data source.

8. The method according to claim 1, wherein: the method further includes:
receiving a subscription request message from a further terminal, the subscription request message including a unique identity of the virtual publisher and a subscriber identity;
judging whether the subscriber has a right for subscription;
if the subscriber has the right for subscription, adding the subscriber to the subscriber list of the virtual publisher;
sending a reply message of successful subscription to the further terminal.

9. An apparatus for processing presence information in a network server, comprising:
a first receiving device for receiving from a terminal a request message for defining a virtual publisher, the request message including a state list, a data source list, a state update rule and a subscriber list of the virtual publisher;
an assigning device for assigning a unique identity for the virtual publisher;
a data source subscription device for judging whether the data source list includes an unsubscribed data source and initiating a subscription to the unsubscribed data source.

10. The apparatus according to claim 9, wherein: the data source list includes a presence information data source and/or a non-presence information data source.

11. The apparatus according to claim 9 or 10, wherein: when the data source list includes a non-presence information data source, the request message further includes a query frequency and a query keyword for the non-presence information data source.

12. The apparatus according to claim 9, wherein: the data source subscription device is further for: sending a subscription request message to the unsubscribed data source when the unsubscribed data source is a presence information data source.

13. The apparatus according to claim 9, wherein: the data source subscription device is further for:
starting a regular query process to the unsubscribed data source when the unsubscribed data source is a non-presence information data sources.

14. The apparatus according to claim 9, wherein: the apparatus further includes:
a second receiving device for receiving a notification message from a data source or receiving a regular query result from a data source, the notification message or the result including the latest state of the data source;
a first determining device for determining virtual publisher(s) corresponding to the data source;
a second determining device for determining the latest state of the virtual publisher in accordance with the state update rule of the virtual publisher and the received latest state of the data source, for each of the virtual publishers;
a first sending device for sending a notification message including the latest state of the virtual publisher to a user in the subscriber list of the virtual publisher, for each of the virtual publishers.

15. The apparatus according to claim 14, wherein: the notification message sent by the first sending device further includes the latest state of the data source or an identity capable of accessing the latest state of the data source.

16. The apparatus according to claim 9, wherein: the apparatus further comprises:
a third receiving device for receiving from a further terminal a subscription request message including a unique identity of the virtual publisher and a subscriber identity;
a judging device for judging whether the subscriber has a right for subscription;
a subscriber management device for adding the subscriber to the subscriber list of the virtual publisher when the subscriber has the right for subscription;
a second sending device for sending a reply message of successful subscription to the further terminal.
